(19) United States
(12) Patent Application Publication
(10) Pub. No.: US 2025/0103011 A1
(43) Pub. Date: Mar. 27, 2025

(54) ESTIMATING TIME OUTDOORS AND IN DAYLIGHT BASED ON AMBIENT LIGHT, MOTION AND LOCATION SENSING

(71) Applicant: Apple Inc., Cupertino, CA (US)

(72) Inventors: Di Wu, San Jose, CA (US); Hui Chen, Los Altos, CA (US); James P. Ochs, San Francisco, CA (US); Paige N. Stanley, San Jose, CA (US); Swaroop Pal, Sunnyvale, CA (US); Mark G. Petovello, Santa Cruz, CA (US); Fatemeh Ghafoori, Santa Clara, CA (US); Isaac T. Miller, Half Moon Bay, CA (US)

(21) Appl. No.: 18/896,745

(22) Filed: Sep. 25, 2024

Related U.S. Application Data
(60) Provisional application No. 63/540,243, filed on Sep. 25, 2023.

(51) Int. Cl. G04F 13/02; G01J 1/42

(52) U.S. Cl. CPC G04F 13/02; G01J 1/42; G01J 2001/4266

(57) ABSTRACT

Embodiments are disclosed for estimating time outdoors and in daylight based on ambient light, motion, and location sensing. In some embodiments, a method comprises detecting daylight based on an ambient light measurement, an estimated sun elevation angle and at least one confidence threshold; determining a motion or activity state of a user based on motion sensor data; determining an indoor or outdoor class based on the motion sensor data and the ambient light detections; determining user exposure time to daylight between, before or after ambient light detections, based on the motion or activity state, and the determined indoor or outdoor class; and storing or displaying the daylight time.

### CROSS-REFERENCE TO RELATED APPLICATION

This application claims priority to U.S. Provisional Patent Application No. 63/540,243, filed Sep. 25, 2023, the entire contents of which are incorporated herein by reference.

### TECHNICAL FIELD

This disclosure relates generally to estimating time outdoor and in daylight.

### BACKGROUND

Studies have shown that time spent outdoors in sunlight has many health benefits, and in particular vision health for children, such as reducing the risk of myopia. Because of the health benefit it is desirable to track the number of hours spent in sunshine. During the course of a day, an individual can be indoors and outdoors many times, making tracking of the total amount of sunshine exposure difficult to determine.

### SUMMARY

Embodiments are disclosed for estimating time outdoors and in daylight based on ambient light, motion, and location sensing.

In some embodiments, a method comprises detecting daylight based on an ambient light measurement, an estimated sun elevation angle and at least one confidence threshold; determining a motion or activity state of a user based on motion sensor data; determining an indoor or outdoor class based on the motion sensor data and the ambient light detections; determining user exposure time to daylight between, before or after ambient light detections, based on the motion or activity state, and the determined indoor or outdoor class; and storing or displaying the daylight time.

In some embodiments, two confidence thresholds are applied to a window of ambient light samples, a first confidence threshold is higher than a second confidence threshold, daylight is detected if there are N samples in the window that meet the first confidence threshold or M samples that meet the second confidence threshold, and a current sample meets the first or second confidence threshold, where M and N are integers and M is greater than N.

In some embodiments, the first and second confidence levels correspond to sun elevation ranges where the higher the elevation range the higher confidence level.

In some embodiments, the motion or activity state is from the group of motion/activity states including sedentary, moving, sustained moving and driving.

In some embodiments, a Bayesian estimator is used to estimate the indoor/outdoor class based on at least one of motion or activity classification, ambient light detection, location estimates, signal environment, audio, pressure or weather conditions.

Other embodiments are directed to an apparatus, system and computer-readable medium.

Particular embodiments described herein provide one or more of the following advantages. Users can automatically track with a mobile device the total amount of sunshine exposure throughout the day even if the user is periodically indoors.

### BRIEF DESCRIPTION OF THE DRAWINGS

FIG. 1 is a block diagram of a system for estimating time outdoors and in daylight based on ambient light, motion, and location sensing, according to one or more embodiments.

FIG. 2 illustrates a lookback window for ambient light sensor (ALS) daylight detection, according to one or more embodiments.

FIG. 3 is a state diagram illustrating various states of a motion classifier, according to one or more embodiments.

FIG. 4 is a flow diagram of a process of estimating time outdoors and in daylight based on ambient light, motion, and location sensing, according to one or more embodiments.

FIG. 5 is a block diagram of a device architecture for implementing the features and processes described in reference to FIGS. 1-4.

FIG. 6 is an expanded state diagram illustrating various states and transition events of a motion state classifier, according to one or more embodiments.

### DETAILED DESCRIPTION

### System Overview

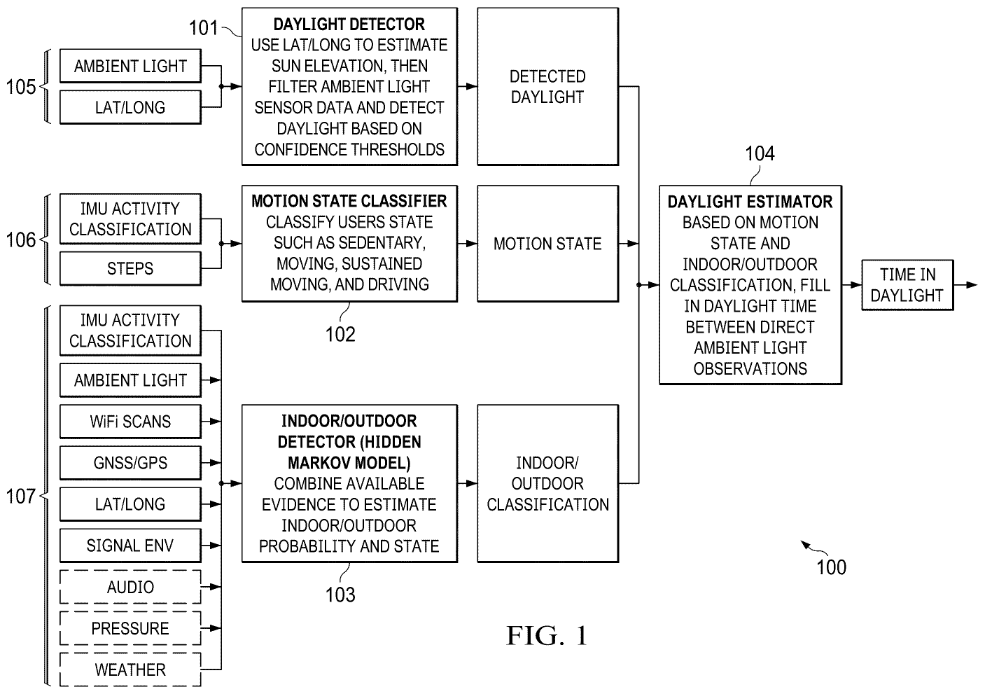

FIG. 1 is a block diagram of a system 100 for estimating time outdoors and in daylight based on ambient light, motion, and location sensing, according to one or more embodiments. System 100 includes daylight detector 101, motion state classifier 102, indoor/outdoor detector 103 and daylight estimator 104.

### ALS Daylight Detection

The ambient light sensor (ALS) continually measures the illuminance of ambient light present. Based on the illuminance values detected, the light source is classified as likely to be daylight or not likely to be daylight based on data-informed confidence thresholds. The confidence thresholds vary based on factors such as the sun elevation for the current time and user location.

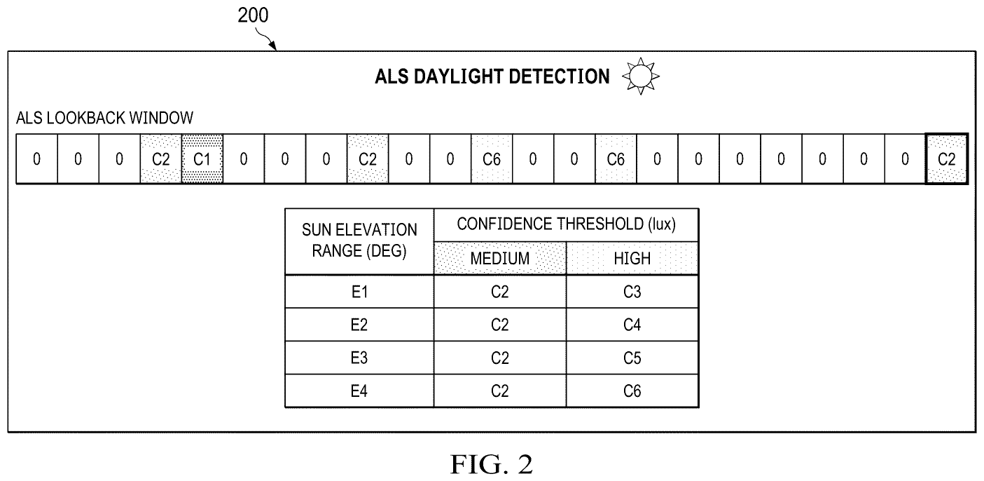

Inputs 105 into daylight detector 101 include ambient light sensor data (e.g., obtained from an ALS) and user location (e.g., latitude, longitude, altitude). Daylight detector 101 uses the user's location to estimate the elevation of the sun at the use's location, filters the ALS data, and classifies the light source as likely or no likely to be daylight based on one or more confidence thresholds, as described in reference to FIG. 2.

In an embodiment, the sun elevation a is estimated as:

$$sin ( α ) = sin ( ϕ ) sin ( δ ) + cos ( ϕ ) cos ( δ ) cos ( h ) , \qquad [ 1 ]$$

where, δ is the declination angle, ϕ is the latitude of the user's location (e.g., determined by GPS), and h is the solar hour angle given by h=15×(LST-12), where LST is local solar time in the 24-hour format. The declaration angle δ can be estimated as:

$$δ = - 23.44 ° x cos ( \frac{360}{365} x ( d + 10 ) ) , \qquad [ 2 ]$$

where d is the number of days since the beginning of January 1^{st} coordinated universal time (UTC).

In some embodiments, a lookup table of illuminance confidence thresholds (in lux) is indexed by the sun elevation (degrees) determined by Equation [1], as shown in FIG. 2.

FIG. 2 illustrates an example ALS lookback window 200 of ambient light samples for ALS daylight detection, according to one or more embodiments. In the example shown, there are 2 confidence thresholds (medium and high) and 4 sun elevation angle ranges (E1-E4). More or less confidence thresholds and/or elevation angle ranges can be used. For all sun elevation angle ranges E1-E4, the medium illuminance confidence threshold is C2. ALS samples that are less than C2 are not counted as daylight. If the estimated sun elevation angle is in the range E1, the high confidence threshold is C3 (where C3>C2), if the estimated sun elevation angle is in range E2, the high confidence threshold is C4 (where C4>C3>C2), if the estimated sun elevation angle is in range E3, the high confidence threshold is L4 (where C5>C4>C3>C2), and if the estimated sun elevation angle is in in range E4, the high confidence threshold is C6 (where C6>C5>C4>C3>C2). Accordingly, as the sun elevation angle increases the high confidence threshold also increases.

In some embodiments, ALS lookback window 200 is an N-minute (e.g., N=1.5-3.5 minutes) lookback window of ALS samples. Each box in the window represents an ALS sample. In this example, the fourth ALS sample is C2, which is the medium confidence threshold. The fifth ALS sample is C1, which is below the medium confidence threshold (C1<C2) and is not counted as daylight. The N-minute lookback window of ALS samples are reviewed to determine a medium or high confidence threshold or no confidence for each sample. Boolean logic is then applied to the confidence thresholds. In some embodiments, if two samples in the lookback window are high confidence OR N samples are medium confidence AND the current sample is medium or high confidence, then the light source is classified as likely daylight for the lookback window. Otherwise, the light source is classified as not likely for the lookback window. The classification is input into daylight estimator 104 to be evaluated with motion state and indoor/outdoor classification to determine the total time in daylight for the lookback window.

The process described above can be continuously run during daylight hours and the determined time in daylight can be stored or displayed to a user on a device (e.g., a smartwatch). The process can be initiated by a user through an interface or programmatically based on local time. The stored time in daylight can be accessed by one or more applications (e.g., health monitoring) applications and further processed or combined with other information.

### Inferring Daylight Exposure Based on User Motion State

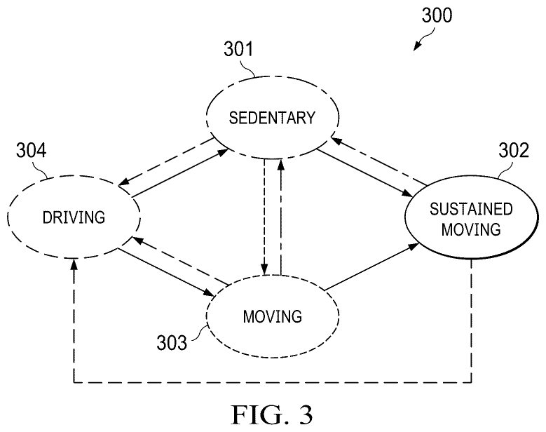

FIG. 3 is a state diagram 300 illustrating various states of a motion state classifier 102, according to one or more embodiments. In some embodiments, inputs 106 to motion state classifier 102 is motion sensor data from motion sensors (e.g., an accelerometer and gyroscope), which are used by motion state classifier 102 to classify the user's activity (e.g., walking, static, cycling, driving, etc.). An example method of user activity classification can be found in, e.g., U.S. Pat. No. 8,892,391, issued Nov. 18, 2014, for “Activity Detection,” which patent is incorporated by reference herein in its entirety. Additionally, input 106 includes step counts. In some embodiments, the accelerometer in a smartwatch is used to count steps taken by the user. An example method of smartwatch step detection is described in, e.g., United States Patent Publication No. US20140074431 A1, published Mar. 13, 2014, for “Wrist Pedometer Step Detection,” which is incorporated by reference herein in its entirety. Based on the step count and activity classification, the user's motion state is classified. Some example motion states include Sedentary 301 (i.e., the user stays in the same location), Sustained Moving 302 (i.e., the user is consistently engaging in activity), Moving 303 (i.e., the user is no longer sedentary), and Vehicle 304. In some embodiments, Boolean logic is used to determine the user's the motion state. For example, if the current user motion state Sedentary 301 and the activity class is walking OR steps are counted, then the user state would transition to Moving 303.

Daylight time (beyond sparse daylight observations) can be added or subtracted to/from the total time in daylight computed for the user based at least in part by the user's motion state. For example, if the user is Sedentary 301 for x minutes, then up to x minutes of daylight can be added to the time in daylight per daylight detection (as determined by daylight detector 101). On the other hand, if the user is in Vehicle 304 for x minutes, up to x minutes of daylight can be subtracted from the time in daylight per daylight detection, as driving in a car may trigger a daylight detection but such detection while driving may not be considered a daylight exposure.

### Classifying Indoor/Outdoor Location by Fusing Sensor Data

To classify the user as indoors or outdoors, input 107 from a variety of sources are opportunistically combined by indoor/outdoor detector 103, including but not limited to motion state/activity classification, ambient light detection, Global Navigation Satellite System (GNSS) measurements (e.g., Global Positioning System (GPS)), and Wi-Fi. Input 107 can be extended to include other input such as audio, pressure and weather conditions, each of which can indicate the indoor/outdoor status of a user. For example, ambient audio captured by a microphone can indicate that a user is outdoors (e.g., the sound of traffic). Pressure combined with map data can indicate that a user is indoors (e.g., in a tall building) or outdoors (e.g., on a mountain). Weather conditions can also indicate that a user is likely to be inside (e.g., rainy, snowy, foggy).

The user's motion state (described in reference to FIG. 3) informs indoor/outdoor detector 103 that the user is likely changing location, or if they are engaging in an activity, more likely to be outdoors (e.g., cycling). The ALS, similar to as described above, can indicate that the user is exposed to sunlight and therefore likely outdoors if it is daytime. Based on the identity, angle, numerosity, and signal strength of GNSS/GPS satellite connections combined with the detected geographic location's signal environment (e.g., urban, suburban, rural) a likelihood estimate that the user is indoor/outdoor can be determined. GNSS/GPS can also be used to estimate distance traveled which indicates location transitions or engagement in activities likely to be outdoors. The signal strength, numerosity, and identity (e.g., airport, home) of Wi-Fi access points informs the likelihood the user is indoor/outdoor. All input sources may not always be available throughout the day, so they are opportunistically combined based on the input sources available to produce an overall indoor/outdoor prediction.

In some embodiments, a Hidden Markov Model (HMM) is used to predict an indoor/outdoor class, where the hidden states are indoor and outdoor and the observable data is GNSS, ALS, Motion/activity state and signal environment (e.g., Wi-Fi.). In some embodiments, a two-step Bayesian estimation method is used to predict and update the prediction. The prediction step uses transition probabilities and the current state to estimate the next state. The update step uses emission likelihoods z (a sequence of observation likelihoods) given a state X (P (z|X)) to update the prediction.

In some embodiments, indoor/outdoor detection is implemented using a wearable computer as described in, e.g., U.S. Pat. No. 10,845,203, assigned to Apple Inc.

Similar to the user motion state (e.g., Sedentary, Moving, Driving, SustainedMoving), the indoor/outdoor class can be used by daylight estimator 104 to determine whether to add or subtract daylight time from the time in daylight beyond sparse daylight-level light observations from the ALS.

In some embodiments, daylight estimator 103 takes as input daylight detections from daylight detector 101, the user's motion state from motion state classifier 102 and an indoor/outdoor classification from indoor/outdoor detector 103. Based on the motion state and indoor/outdoor classification, the daylight time between, before or after the daylight detections can be determined. For example, assume that the ALS detects light at time t₀ and ten minutes later at t₁₀. Daylight estimator 104 determines that during this time window the user was Sedentary and outdoors, then daylight estimator 104 will credit the time between t₀ and t₁₀ as time in daylight. By another example, we assume the time between daylight detections is time t₁₀ and time t₁ₕ (1 hour later). During this window, the user is driving and indoors. In this example, the daylight estimator 104 will not credit the time between time t₁₀ and time tin as user exposure time to daylight.

### Example Process

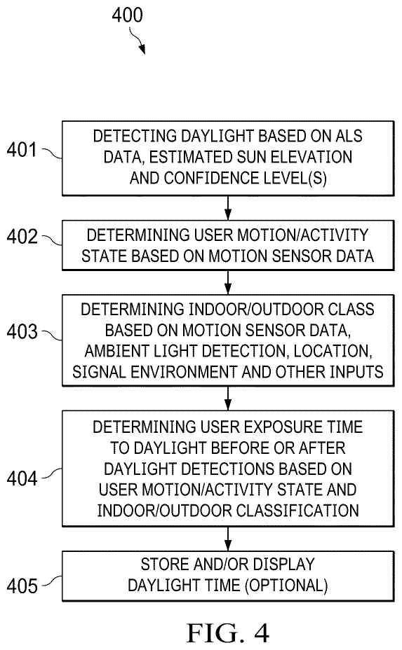

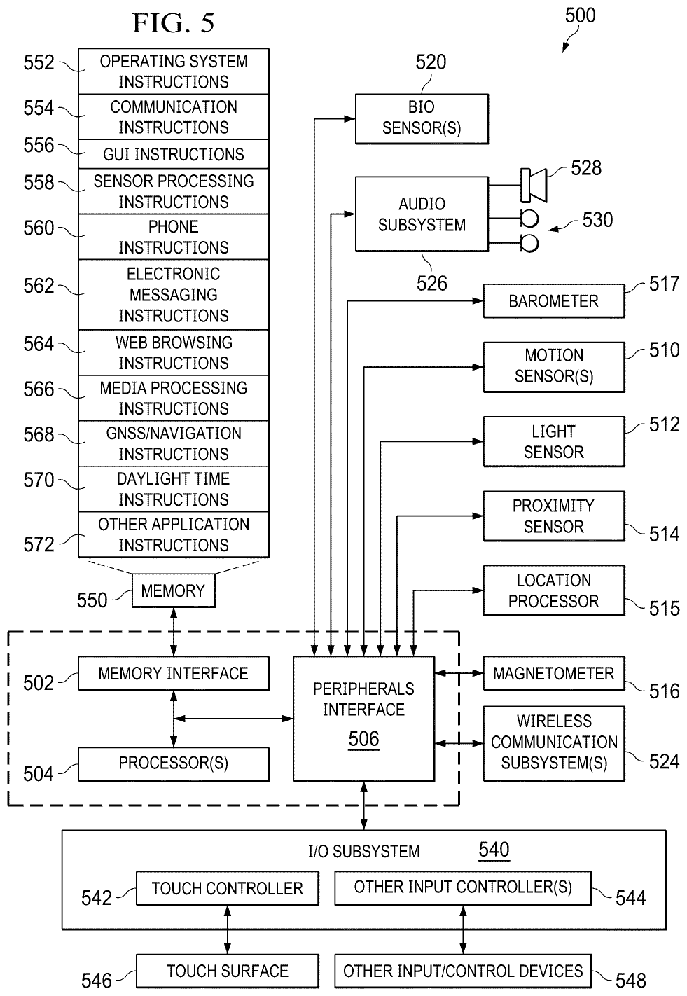

FIG. 4 is a flow diagram of process 400 of estimating time outdoors and in daylight based on ambient light, motion, and location sensing, according to one or more embodiments. Process 400 can be implemented in, e.g., device architecture 500 described in reference to FIG. 5.

In some embodiments, process 400 includes: detecting ambient light based on estimated sun elevation angle and at least one confidence threshold (401); determining a motion or activity state of a user based on motion sensor data (402); determining an indoor or outdoor class based on the motion sensor data and the ambient light detections (403); determining user exposure time to daylight between two ambient light detections, based on the motion or activity state, and the determined indoor or outdoor class (404); and storing or displaying the daylight time (405). Each of these steps was previously described above in reference to FIGS. 1-3.

The foregoing process has several applications. For example, process 400 can be used to track a child's time spent outdoors and in daylight and coaching parents on guidelines to improve vision health (e.g., reduce risk of myopia). Process 400 can also track a user's time spent outdoors and in daylight as a foundation for mental health. Process 400 can improve location estimation by identifying building entry/exit and determining workout location (indoor/outdoor) for improved exertion estimation accuracy

### Example Device Architecture

FIG. 5 is a block diagram of a device architecture 500 for implementing the features and processes described in reference to FIGS. 1-4. Architecture 500 can include memory interface 502, one or more hardware data processors, image processors and/or processors 504 and peripherals interface 506. Memory interface 502, one or more processors 504 and/or peripherals interface 506 can be separate components or can be integrated in one or more integrated circuits. System architecture 500 can be included in any suitable electronic device for crash detection, including but not limited to: a smartwatch, smartphone, fitness band and any other device that can be attached, worn, or held by a user.

Sensors, devices, and subsystems can be coupled to peripherals interface 506 to provide multiple functionalities. For example, one or more motion sensors 510, light sensor 512 and proximity sensor 514 can be coupled to peripherals interface 506 to facilitate motion sensing (e.g., acceleration, rotation rates), lighting and proximity functions of the wearable device. Location processor 515 can be connected to peripherals interface 506 to provide geo-positioning. In some implementations, location processor 515 can be a GNSS receiver, such as the Global Positioning System (GPS) receiver. Electronic magnetometer 516 (e.g., an integrated circuit chip) can also be connected to peripherals interface 506 to provide data that can be used to determine the direction of magnetic North. Electronic magnetometer 516 can provide data to an electronic compass application. Motion sensor(s) 510 can include one or more accelerometers and/or gyros configured to determine change of speed and direction of movement. Barometer 517 can be configured to measure atmospheric pressure (e.g., pressure change inside a vehicle). Bio signal sensor 520 can be one or more of a PPG sensor, an electroencephalogram (EEG) sensor, an electrocardiogram (ECG) sensor, an electromyogram (EMG) sensor, a mechanomyogram (MMG) sensor (e.g., piezo resistive sensor) for measuring muscle activity/contractions, an electrooculography (EOG) sensor, a galvanic skin response (GSR) sensor, a magnetoencephalogram (MEG) sensor and/or other suitable sensor(s) configured to measure bio signals.

Communication functions can be facilitated through wireless communication subsystems 524, which can include radio frequency (RF) receivers and transmitters (or transceivers) and/or optical (e.g., infrared) receivers and transmitters. The specific design and implementation of the communication subsystem 524 can depend on the communication network(s) over which a mobile device is intended to operate. For example, architecture 500 can include communication subsystems 524 designed to operate over a GSM network, a GPRS network, an EDGE network, a WiFi™ network and a Bluetooth™ network. In particular, the wireless communication subsystems 524 can include hosting protocols, such that the crash device can be configured as a base station for other wireless devices.

Audio subsystem 526 can be coupled to a speaker 528 and a microphone 530 to facilitate voice-enabled functions, such as voice recognition, voice replication, digital recording, and telephony functions. Audio subsystem 526 can be configured to receive voice commands from the user.

I/O subsystem 540 can include touch surface controller 542 and/or other input controller(s) 544. Touch surface controller 542 can be coupled to a touch surface 546. Touch surface 546 and touch surface controller 542 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with touch surface 546. Touch surface 546 can include, for example, a touch screen or the digital crown of a smart watch. I/O subsystem 540 can include a haptic engine or device for providing haptic feedback (e.g., vibration) in response to commands from processor 504. In an embodiment, touch surface 546 can be a pressure-sensitive surface.

Other input controller(s) 544 can be coupled to other input/control devices 548, such as one or more buttons, rocker switches, thumbwheel, infrared port, and USB port. The one or more buttons (not shown) can include an up/down button for volume control of speaker 528 and/or microphone 530. Touch surface 546 or other controllers 544 (e.g., a button) can include, or be coupled to, fingerprint identification circuitry for use with a fingerprint authentication application to authenticate a user based on their fingerprint(s).

In one implementation, a pressing of the button for a first duration may disengage a lock of the touch surface 546; and a pressing of the button for a second duration that is longer than the first duration may turn power to the mobile device on or off. The user may be able to customize a functionality of one or more of the buttons. The touch surface 546 can, for example, also be used to implement virtual or soft buttons.

In some implementations, the mobile device can present recorded audio and/or video files, such as MP3, AAC and MPEG files. In some implementations, the mobile device can include the functionality of an MP3 player. Other input/output and control devices can also be used.

Memory interface 502 can be coupled to memory 550. Memory 550 can include high-speed random-access memory and/or non-volatile memory, such as one or more magnetic disk storage devices, one or more optical storage devices and/or flash memory (e.g., NAND, NOR). Memory 550 can store operating system 552, such as the iOS operating system developed by Apple Inc. of Cupertino, California. Operating system 552 may include instructions for handling basic system services and for performing hardware dependent tasks. In some implementations, operating system 552 can include a kernel (e.g., UNIX kernel).

Memory 550 may also store communication instructions 554 to facilitate communicating with one or more additional devices, one or more computers and/or one or more servers, such as, for example, instructions for implementing a software stack for wired or wireless communications with other devices. Memory 550 may include graphical user interface instructions 556 to facilitate graphic user interface processing; sensor processing instructions 558 to facilitate sensor-related processing and functions; phone instructions 560 to facilitate phone-related processes and functions; electronic messaging instructions 562 to facilitate electronic-messaging related processes and functions; web browsing instructions 564 to facilitate web browsing-related processes and functions; media processing instructions 566 to facilitate media processing-related processes and functions; GNSS/Location instructions 568 to facilitate generic GNSS and location-related processes and instructions; and instructions 570 that implement the processes described in reference to FIGS. 1-4. Memory 550 further includes other application instructions 572 including but not limited to instructions for applications that implement system 100 shown in FIG. 1 (e.g., health monitoring applications).

Each of the above identified instructions and applications can correspond to a set of instructions for performing one or more functions described above. These instructions need not be implemented as separate software programs, procedures, or modules. Memory 550 can include additional instructions or fewer instructions. Furthermore, various functions of the mobile device may be implemented in hardware and/or in software, including in one or more signal processing and/or application specific integrated circuits.

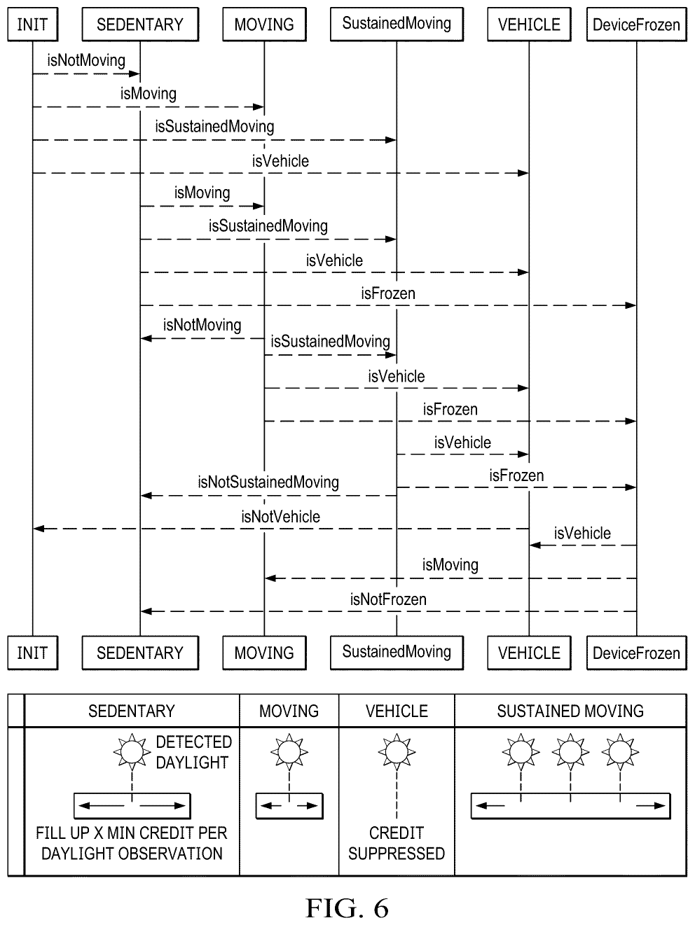

FIG. 6 is an expanded state diagram illustrating various states and transition events of a motion state classifier, according to one or more embodiments. The motion states are shown at the top and bottom and include Initial (Init), Sedentary, Moving, SustainedMoving, Vehicle and DeviceFrozen. Referring to the left of the diagram, starting from the Init state, the state machine transitions to Sedentary if the user is not moving, transitions to Moving if the user is moving, transitions to SustainedMoving if the user is motion is sustained, and transitions to Vehicle if the user is in a vehicle. If the user is Sedentary and starts moving, then the Sedentary state transitions to the Moving state, and so on. Referring to the bottom of the diagram, one can see that each state is associated with a daylight fill rule. For example, while Sedentary x minutes of daylight are credited/awarded per each daylight observation/detection. While in the Vehicle state, credit is suppressed.

In some embodiments, daylight credit is evenly added before or after an instance where daylight was observed. For example, if daylight was observed while in the SustainedMoving state daylight, the same daylight credit would be added before and after daylight detection, in accordance with the daylight fill rule for the SustainedMoving state.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

As described above, some aspects of the subject matter of this specification include gathering and use of data available from various sources to improve services a mobile device can provide to a user. The present disclosure contemplates that in some instances, this gathered data may identify a particular location or an address based on device usage. Such personal information data can include location-based data, addresses, subscriber account identifiers, or other identifying information.

The present disclosure further contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

In the case of advertisement delivery services, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publicly available information.

What is claimed is:

1. A method comprising:
detecting, with at least one processor, daylight based on an ambient light measurement, an estimated sun elevation angle and at least one confidence threshold;
determining, with the at least one processor, a motion or activity state of a user based on motion sensor data;
determining, with the at least one processor, an indoor or outdoor class based on the motion sensor data and the ambient light detections;
determining, with the at least one processor, user exposure time to daylight between, before or after ambient light detections, based on the motion or activity state, and the determined indoor or outdoor class; and
storing or displaying, with the at least one processor, the daylight time.

2. The method of claim 1, wherein two confidence thresholds are applied to a window of ambient light samples, a first confidence threshold is higher than a second confidence threshold, daylight is detected if there are N samples in the window that meet the first confidence threshold or M samples that meet the second confidence threshold, and a current sample meets the first or second confidence threshold, where M and N are integers and M is greater than N.

3. The method of claim 1, wherein the first and second confidence levels correspond to sun elevation ranges where the higher the elevation range the higher confidence level.

4. The method of claim 1, wherein the motion or activity state is from the group of motion/activity states including sedentary, moving, sustained moving and driving.

5. The method of claim 1, wherein a Bayesian estimator is used to estimate the indoor/outdoor class based on at least one of motion or activity classification, ambient light detection, location estimates, signal environment, audio, pressure or weather conditions.

6. A system comprising:
one or more processors;
memory storing instructions that when executed by the one or more processors, causes the one or more processors to perform operations comprising:
detecting daylight based on an ambient light measurement, an estimated sun elevation angle and at least one confidence threshold;
determining a motion or activity state of a user based on motion sensor data;
determining an indoor or outdoor class based on the motion sensor data and the ambient light detections;
determining user exposure time to daylight between, before or after ambient light detections, based on the motion or activity state, and the determined indoor or outdoor class; and
storing or displaying the daylight time.

7. The system of claim 6, wherein two confidence thresholds are applied to a window of ambient light samples, a first confidence threshold is higher than a second confidence threshold, daylight is detected if there are N samples in the window that meet the first confidence threshold or M samples that meet the second confidence threshold, and a current sample meets the first or second confidence threshold, where M and N are integers and M is greater than N.

8. The system of claim 6, wherein the first and second confidence levels correspond to sun elevation ranges where the higher the elevation range the higher confidence level.

9. The system of claim 6, wherein the motion or activity state is from the group of motion/activity states including sedentary, moving, sustained moving and driving.

10. The system of claim 6, wherein a Bayesian estimator is used to estimate the indoor/outdoor class based on at least one of motion or activity classification, ambient light detection, location estimates, signal environment, audio, pressure or weather conditions.

11. A non-transitory computer-readable medium having stored thereon instructions that when executed by one or more processors, cause the one or more processors to perform operations comprising:
detecting daylight based on an ambient light measurement, an estimated sun elevation angle and at least one confidence threshold;
determining a motion or activity state of a user based on motion sensor data;
determining an indoor or outdoor class based on the motion sensor data and the ambient light detections;
determining user exposure time to daylight between, before or after ambient light detections, based on the motion or activity state, and the determined indoor or outdoor class; and
storing or displaying the daylight time.

12. The non-transitory computer-readable medium of claim 11, wherein two confidence thresholds are applied to a window of ambient light samples, a first confidence threshold is higher than a second confidence threshold, daylight is detected if there are N samples in the window that meet the first confidence threshold or M samples that meet the second confidence threshold, and a current sample meets the first or second confidence threshold, where M and N are integers and M is greater than N.

13. The non-transitory computer-readable medium of claim 11, wherein the first and second confidence levels correspond to sun elevation ranges where the higher the elevation range the higher confidence level.

14. The non-transitory computer-readable medium of claim 11, wherein the motion or activity state is from the group of motion/activity states including sedentary, moving, sustained moving and driving.

15. The non-transitory computer-readable medium of claim 11, wherein a Bayesian estimator is used to estimate the indoor/outdoor class based on at least one of motion or activity classification, ambient light detection, location estimates, signal environment, audio, pressure or weather conditions.
